(19) United States
(12) Patent Application Publication
(10) Pub. No.: US 2025/0196871 A1
(43) Pub. Date: Jun. 19, 2025

(54) VEHICLE CONTROL DEVICE, VEHICLE CONTROL SYSTEM, ACCEPTANCE DETERMINATION METHOD, AND STORAGE MEDIUM STORING PROGRAM

(71) Applicant: DENSO CORPORATION, Kariya-city (JP)

(72) Inventors: Hideyuki HONYA, Kariya-city (JP); Hideyuki Yamaguchi, Kariya-city (JP)

(21) Appl. No.: 19/062,458

(22) Filed: Feb. 25, 2025

Related U.S. Application Data
(63) Continuation of application No. PCT/JP2023/031990, filed on Aug. 31, 2023.

(30) Foreign Application Priority Data
Sep. 2, 2022 (JP) 2022-140066

(51) Int. Cl. B60W 50/10; B60R 16/023; B60W 50/14

(52) U.S. Cl. CPC B60W 50/10; B60R 16/0231; B60W 50/14

(57) ABSTRACT

A vehicle control device mounted on a vehicle and configured to control the vehicle is provided. The vehicle control device is configured to implement cooperation between an application configured to provide a service to the vehicle and a functional block configured to perform processing in the vehicle. The functional block is configured to convert a first command represented in a form independent of the vehicle and transmitted from the application into a second command in a form dependent on the vehicle and output the second command. The first command transmitted from the application is transferred to the functional block. The vehicle control device is further configured to determine whether the first command meets an intention of a user, and not to cause the functional block to output the second command when it is determined that the first command does not meet the intention of the user.

### CROSS REFERENCE TO RELATED APPLICATION

The present application is a continuation application of International Patent Application No. PCT/JP2023/031990 filed on Aug. 31, 2023 which designated the U.S. and claims the benefit of priority from Japanese Patent Application No. 2022-140066 filed on Sep. 2, 2022. The entire disclosures of all of the above applications are incorporated herein by reference.

### TECHNICAL FIELD

The present disclosure relates to a vehicle control device.

### BACKGROUND

A related art discloses an in-vehicle device for appropriately preventing execution of inappropriate vehicle remote control from a user. Specifically, in a case where the air conditioner is operated by the vehicle remote control from the user, when the presence of a person or an animal in the vehicle cabin or around the vehicle is detected, the in-vehicle device forcibly operates the air conditioner in the automatic mode, ignoring the designation of cooling and heating and the designation of a set temperature from the user.

### SUMMARY

A vehicle control device mounted on a vehicle and configured to control the vehicle is provided. The vehicle control device is configured to implement cooperation between an application configured to provide a service to the vehicle and a functional block configured to perform processing in the vehicle. The functional block is configured to convert a first command represented in a form independent of the vehicle and transmitted from the application into a second command in a form dependent on the vehicle and output the second command. The first command transmitted from the application is transferred to the functional block. The vehicle control device is further configured to determine whether the first command meets an intention of a user, and not to cause the functional block to output the second command when it is determined that the first command does not meet the intention of the user.

### BRIEF DESCRIPTION OF DRAWINGS

Objects, features and advantages of the present disclosure will become more apparent from the following detailed description made with reference to the accompanying drawings. In the drawings:

FIG. 1 is a block diagram illustrating a configuration of a vehicle control system;

FIG. 2 is a block diagram illustrating a functional configuration of a processing section;

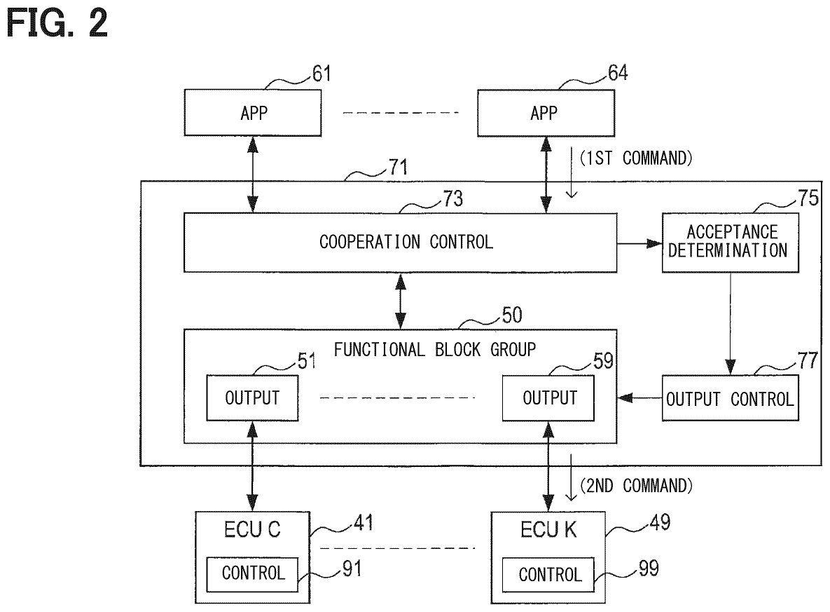

FIG. 3 is a flowchart illustrating a basic operation of the processing section illustrated in FIG. 2;

FIG. 4 is a flowchart of notification setting processing; and

FIG. 5 is a flowchart illustrating a modification of the basic operation of the processing section.

### DETAILED DESCRIPTION

In the future, it is assumed that an unspecified number of applications manufactured by third parties access the vehicle system. As a result of detailed studies by the inventors, it has been found that there is a possibility that these applications access functions and information of the vehicle at a timing or with contents not intended by the user and operate the vehicle.

The present disclosure provides a technique capable of suppressing execution of an application regardless of intention of a user.

One embodiment of the present disclosure is a vehicle control device mounted on a vehicle and configured to control the vehicle.

The vehicle control device comprises a cooperation control section configured to implement cooperation between an application configured to provide a service to the vehicle and a functional block configured to perform predetermined processing in the vehicle.

The functional block includes an output section configured to convert a first command represented in a form independent of the vehicle and transmitted from the application into a second command in a form dependent on the vehicle and output the second command to an operation control section for controlling an object to be controlled. The cooperation control section is configured to transfer the first command transmitted from the application to the functional block.

The vehicle control device further comprises an acceptance determination section and an output control section.

The acceptance determination section is configured to determine whether the first command meets the intention of a user, and the output control section is configured not to cause the output section to output the second command in a case where the acceptance determination section determines that the first command does not meet the intention of the user.

According to such a configuration, it is possible to suppress the execution of the application regardless of the intention of the user.

Hereinafter, exemplary embodiments of the present disclosure will be described with reference to the drawings.

### 1. Embodiment

### 1-1. Correspondence Between Configuration of Embodiment and Configuration of Present Disclosure

In the following embodiment, an ECUA 10 corresponds to a vehicle control device in the present disclosure.

The processing at S103 in the embodiment corresponds to the functions of an acceptance determination section and an output control section in the present disclosure. The processing at S104 in the embodiment corresponds to the function of an output section in the present disclosure. The processing at S105 in the embodiment corresponds to the function of a matching determination section in the present disclosure. The processing at S106 in the embodiment corresponds to the functions of an output permission section and a storage section in the present disclosure. The processing at S107 in the embodiment corresponds to the function of a notification section in the present disclosure. The processing at S204 in the embodiment corresponds to the function of a notification setting section in the present disclosure.

### 1-2. Configuration

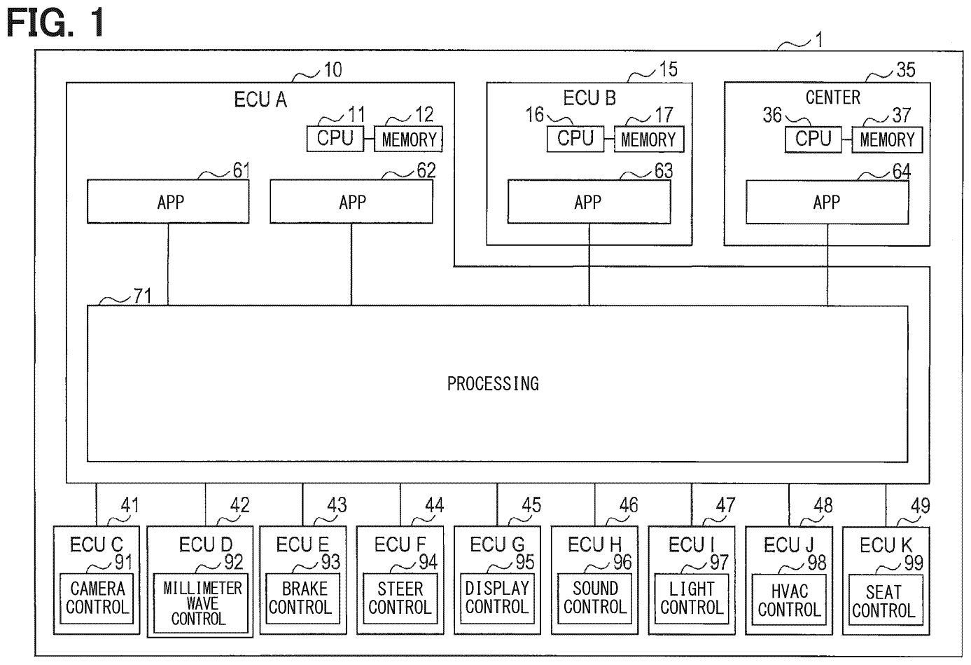

A vehicle control system 1 illustrated in FIG. 1 is mostly mounted on a vehicle such as a passenger car and includes a plurality of ECUs 10, 15, and 41 to 49 (hereinafter, a large number of ECUs 10 and the like). The vehicle control system 1 may include a center 35 outside the vehicle.

The center 35 is configured as a server capable of providing a function to the vehicle. The center 35 can provide a function related to automated driving or the like to the vehicle, for example.

The large number of ECUs 10 and the like and the center 35 are mainly configured by known microcomputers having CPUs 11, 16, and 36 (hereinafter, CPUs 11 to 36) and semiconductor memories 12, 17, and 37 (hereinafter, memories 12 to 37) such as RAMs, ROMs, and flash memories. The ECUs 41 to 49 also include a CPU and a memory, but illustration thereof is omitted. In addition, the ECU represents to an electronic control device.

The large number of ECUs 10 and the like and the center 35 are configured to control an object to be controlled mounted on the vehicle. Examples of the object to be controlled include an engine, a brake, a motor, various lights, a display device, an air conditioner, a seat, a horn, and a power generator. The illustration of the objects to be controlled is omitted.

The objects to be controlled are individually controlled by the ECUs 41 to 49, which are operation control devices. The ECUs 41 to 49 include an ECUC 41 including a camera control section 91, an ECUD 42 including a millimeter wave control section 92, an ECUE 43 including a brake control section 93, and an ECUF 44 including a steer control section 94. In addition, an ECUG 45 including a display control section 95, an ECUH 46 including a sound control section 96, an ECUI 47 including a light control section 97, an ECUJ 48 including an HVAC control section 98, and an ECUK 49 including a seat control section 99 are included.

Each of the control sections 91 to 99 includes an operation control section for operating the object to be controlled. The operation control section is, for example, an operation control program. The camera control section 91 acquires a captured image from an in-vehicle camera and controls the exposure and the like of the in-vehicle camera. The millimeter wave control section 92 controls a millimeter wave radar provided in the vehicle and acquires a detection result obtained by the millimeter wave radar.

The brake control section 93 controls the brake. The steer control section 94 controls steering. The display control section 95 controls an indicator such as a meter or a warning light. The sound control section 96 controls sound such as a warning sound or a voice generated from a speaker. The light control section 97 controls various lights mounted on the vehicle.

The HVAC control section 98 controls an in-vehicle air conditioner. HVAC stands for Heating Ventilation and Air-Conditioning. The seat control section 99 controls an electric power seat of the vehicle.

Various functions of a large number of ECUs 10 and the like and the center 35 are implemented by the CPUs 11 to 36 executing a program stored in a non-transitory tangible recording medium. In this example, the memories 12 to 37 correspond to non-transitory tangible recording mediums storing a program. Furthermore, by executing this program, a method corresponding to the program is performed. The non-transitory tangible recording medium means that electromagnetic waves are excluded from the recording medium. The number of microcomputers constituting a large number of ECUs 10 and the like and the center 35 may be one or plural.

Among a large number of ECUs 10 and the like, the ECUA 10 implements functions as applications (hereinafter, applications) 61 and 62 and a processing section 71 by executing programs. The ECUB 15 implements a function as an application 63. The center 35 implements a function as an application 64.

The applications 61 to 64 are programs for providing services to a user of the vehicle. The applications 61 to 64 indirectly transmits a command to the object to be controlled and operates the object to be controlled, thereby providing a useful function to the user. These applications 61 to 64 may be installed in the ECUA 10, the ECUB 15, or the center 35.

More specifically, the applications 61 to 64 are configured to generate a first command that is a command not designating the control sections 91 to 99 to be described later for the processing section 71. “Command” includes a command such as an operation request, a command such as an argument, a function call, and the like among the data used in the processing section 71. “Command” may include priority information indicating which command should be preferentially processed.

The applications 61 to 64 are not programs created specifically for vehicle types, grades, and the like, but general-purpose programs that can support many vehicle types, grades, and the like. Therefore, the applications 61 to 64 cannot specify how the vehicle having the applications installed therein controls the object to be controlled. For this reason, the applications 61 to 64 output a command not designating a specific controlled variable of the object to be controlled, in other words, the control sections 91 to 99 used by the processing section 71. On the other hand, the applications 61 to 64 generate a desired abstract operation content. For example, the applications 61 to 64 only give a command as to the operation content of turning on the light, and does not specifically include which light is to be turned on in the operation content.

Hereinafter, at least one of the applications 61 to 64 is also referred to as “service application 6”.

Unlike the applications 61 to 64, the processing section 71 has a program created specifically for a vehicle type, a grade, and the like. That is, the processing section 71 has a program that absorbs the difference in vehicle type, grade, and the like in a manner that the applications 61 to 64 do not need to be aware of the difference in vehicle type, grade, and the like.

The processing section 71 is mounted on the ECUA 10. The processing section 71 accepts commands (hereinafter, first commands) from a plurality of applications 61 to 64 mounted on the ECUA 10 that is a subject ECU, the ECUB 15 that is another ECU, and the center 35.

The processing section 71 is also a program for controlling the object to be controlled. For example, the processing section 71 calculates the operation amount of an actuator, which is the object to be controlled, and transmits a command (hereinafter, second command) including the operation amount to the various control sections 91 to 99. That is, the processing section 71 includes a cooperation control section 73, a functional block group 50, an acceptance determination section 75, and an output control section 77.

Here, when the first command is input from the plurality of applications 61 to 64, the cooperation control section 73 selects an object to be controlled in accordance with the first command and outputs the first command to the functional block group 50. In a case where the first commands are simultaneously input from the plurality of applications 61 to 64, the cooperation control section 73 may arbitrate the first commands. The cooperation control section 73 outputs the first command determined to be executable to the functional block group 50 as a result of the arbitration.

The acceptance determination section 75 determines whether or not the first command meets the intention of the user on the basis of the instruction from the cooperation control section 73. When the acceptance determination section 75 determines that the first command does not meet the intention of the user, the output control section 77 does not cause each of output sections 51 to 59 to output the second command based on the first command to each of the ECUs 41 to 49. In this case, the output control section 77 may prevent the first command from being output from the cooperation control section 73 to the functional block group 50.

In addition, the functional block group 50 includes the output sections 51 to 59 that convert the first command input from the cooperation control section 73 into an embodied second command and outputs the second command to the ECUs 41 to 49 of the corresponding control sections 91 to 99. The output sections 51 to 59 output the second command in which the control parameter, the operation amount, and the like of the object to be controlled are embodied to the corresponding ECUs 41 to 49.

For example, when the first command to turn on the light is input from the applications 61 to 64, the cooperation control section 73 specifies a specific object to be controlled such as which light is to be turned on, and outputs the specified object to be controlled to the functional block group 50. Then, in the functional block group 50, the output sections 51 to 59 set the lighting pattern (for example, interval at the time of blinking, and the like) of the light based on the first command, and output the pattern to the control sections 91 to 99 as the second command to turn on the light.

The processing section 71 is also a program for transmitting data obtained from a sensor or the like to the service application 6. In other words, the processing section 71 implements the function of “state recognition” and the function of “equipment control”. In the function of state recognition, sensor data obtained from each of the control sections 91 to 99 to be described later is converted into a format suitable for the processing section 71. In the function of equipment control, a drive instruction from the processing section 71 is distributed to the individual control sections 91 to 99.

In the function of state recognition, the function of classifying individual sensor raw data acquired from a vehicle sensor into data for each sensing target that is easy for the service application 6 to use is implemented. In addition, data integration is performed, and conversion into information with a higher abstraction level is performed.

For example, in the function of state recognition, the control sections 91 to 99 acquire individual information such as a vehicle speed of 0 km/h, a shift position P, and no driver is present in the vehicle, and information indicating that the vehicle is in a parking state is output on the basis of these pieces of information. This information is transmitted to the service application 6.

For example, in a case where the service application 6 makes a request for a car finder, the processing section 71 may combine ack from the light and ack from the horn, which are responses to the control request for the light and the horn, into one operation result and respond to the service application 6. The car finder is a function of an application that notifies the user of the position of the vehicle in a parking lot or the like in an easy-to-understand manner.

In addition, in the function of equipment control, as described above, the individual control sections 91 to 99 (for example, an engine, a steering, a shift, a door, a window, an air conditioner, and the like) optimal for implementing the vehicle operation request from the service application 6 are selected. The data is then converted into a data format that can be received by the individual control sections 91 to 99, and the data is distributed in consideration of the order of transmission of the data.

For example, when the vehicle operation request is “accelerate the vehicle at 0.3 G while turning left at R200 m”, “request for engine to output 1000 Nm and request for steering to output −0.1 rad” are output in the function of equipment control.

Furthermore, for example, it is assumed that the vehicle operation request is “shift to parking state”. In this case, in the function of equipment control, “request to shift to P, request to turn off air conditioner, request to fully close window, request to lock door and request to shift to parking state when requests are completed and no occupant is present” are output.

### 1-3. Processing

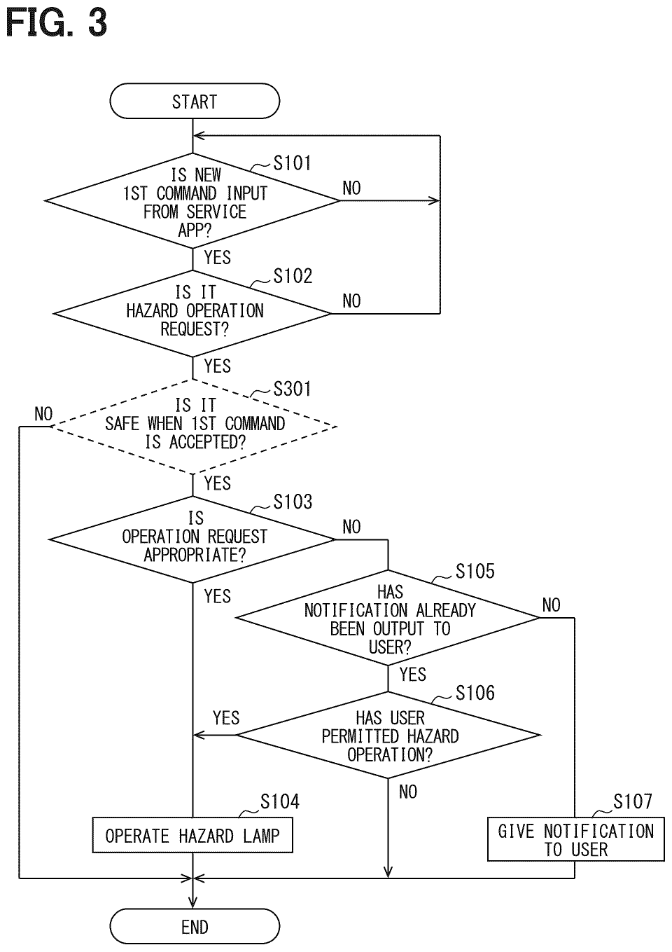

Next, basic processing performed by the processing section 71 to implement the functions as the acceptance determination section 75 and the output control section 77 will be described with reference to the flowchart of FIG. 3. In this processing, a series of flows in a case where a hazard operation request is received from the service application 6 will be described. The service application 6 in this processing is an application related to a car finder that notifies the user of the position of the vehicle by blinking the hazard lamp, for example.

First, in S101, the processing section 71 determines whether or not a new first command is input from the service application 6.

When determining that the new first command is input from the service application 6 in S101, the processing section 71 proceeds to S102.

On the other hand, when determining in S101 that the new first command is not input from the service application 6, the processing section 71 repeats S101.

In S102, the processing section 71 determines whether or not the new first command is a command indicating the hazard operation request.

When determining in S102 that the new first command is a command indicating the hazard operation request, the processing section 71 proceeds to S103.

On the other hand, when determining in S102 that the new first command is not the command indicating the hazard operation request, the processing section 71 returns to S101.

In S103, the processing section 71 performs processing as the acceptance determination section 75 that determines whether or not the first command meets the intention of the user. Specifically, the processing section 71 determines whether or not the first command meets the intension of the user on the basis of at least one of vehicle equipment, a vehicle state, or a vehicle environment.

“Meeting the intention of the user” means that the state where the safety of the user is ensured, the user does not feel uneasy, the user is more comfortable, the vehicle can travel well, or the like can be maintained, or the state can be shifted to these states.

Determining whether or not the first command meets the intention of the user may involve a viewpoint of “timing” and a viewpoint of “content”. The viewpoint of “timing” is a viewpoint of determining whether or not it is a time point at which the execution of the first command is not appropriate. The viewpoint of “content” is a viewpoint of determining whether or not it is a situation in which a contradiction occurs or discomfort is given to the user when the first command is executed.

The situation in which a contradiction occurs when the first command is executed is a situation in which, if the first command is executed, the situation is shifted from a state before the first command is executed to a completely opposite state. As will be described later in another embodiment (2a), examples of the situation include a case where the first command to start cooling is input in a state where heating is applied and a case where the first command to close the side window is input even though the open button of the side window is being pressed.

Here, for example, in a case where there is a possibility that the battery level lowers and the vehicle cannot travel when the application is executed, it is determined that it does not meet the intention of the user. In addition, also in a case where the function of the car finder is unnecessary and the unintended turning on of the hazard lamp is inappropriate as in a case where the vehicle is traveling, it is determined that it does not meet the intention of the user. Furthermore, in a case where another application for opening the door of the vehicle is executed, for example, in a case where it is inappropriate to open the door of the vehicle as in a case where the vehicle is traveling at a high speed on a highway, it is determined that it does not meet the intention of the user.

The vehicle equipment indicates equipment in a vehicle on which the vehicle control system 1 is mounted. For example, the vehicle equipment includes a voltage value of the device, a power supply state of the device, and the like. The vehicle state indicates a state inside the vehicle on which the vehicle control system 1 is mounted. For example, the vehicle state includes states of various switches, a temperature inside the vehicle, and the like. The vehicle environment indicates an environment around the vehicle on which the vehicle control system 1 is mounted. For example, the vehicle environment includes information about weather, time period, and the like. The processing section 71 may determine whether or not the first command meets the intention of the user on the basis of two or more pieces of information of the vehicle equipment, the vehicle state, and the vehicle environment.

In the present embodiment, the processing section 71 determines whether or not the hazard operation request meets the intention of the user on the basis of the vehicle equipment. When determining in S103 that the first command meets the intention of the user, the processing section 71 proceeds to S104 and operates the hazard lamp.

That is, in S104, one or a plurality of control sections 91 to 99 optimal for operating the hazard lamp is selected. The data is then converted into a data format that can be received by the individual control sections 91 to 99, and the data is distributed in consideration of the order of transmission of the data.

On the other hand, when determining in S103 that the first command does not meet the intention of the user, the processing section 71 proceeds to S105. That is, when determining in S103 that the first command does not meet the intention of the user, the processing section 71 does not output the second command based on the first command.

In S104, the processing section 71 operates the hazard lamp. At this time, the processing section 71 enables the application for operating the hazard lamp. As a result, the processing section 71 can output the second command based on the first command to the operation control section for controlling the object to be controlled.

Each of the control sections 91 to 99 includes an operation control section for operating the object to be controlled, and each of the control sections 91 to 99 that has received the operation instruction implements the operation control section. That is, an operation control program constituting each of the control sections 91 to 99 is stored in the memory of each of the ECUs 41 to 49, which are operation control devices, and the program is executed by the CPU.

In the present embodiment, the processing section 71 outputs the second command based on the first command to the light control section 97 for controlling various lights. Specifically, the processing section 71 outputs “request to blink headlight and taillight” as the second command. The light control section 97 executes the operation control of the object to be controlled on the basis of the second command. Thereafter, the processing section 71 terminates this processing.

In step S105, the processing section 71 determines whether or not a notification for inquiring whether or not to execute the application that has output the first command has already been output.

When determining in S105 that the notification for inquiring whether or not to execute the application that has output the first command has already been output, the processing section 71 proceeds to S106.

Here, in a case where the condition at the time of making an inquiry to the user before is different from the current condition, the processing section 71 may make an inquiry again. This is because even if the user has already responded as to whether to permit the execution of the application, the user may wish to select a response different from the previous response depending on the condition (for example, whether the vehicle is traveling, stopped, ambient brightness, or the like).

Therefore, even in a case where the processing section 71 determines that the notification for inquiring whether to execute the application that has output the first command has already been output, if it is determined in S105 that a comparison condition does not match a permission condition, the processing section proceeds to S107.

More specifically, the processing section 71 determines whether or not the comparison condition matches the permission condition. The comparison condition is at least one of the vehicle equipment, the vehicle state, or the vehicle environment when the first command related to the application is input. In the present embodiment, the vehicle equipment information in this processing cycle corresponds to the comparison condition. The permission condition is at least one of the vehicle equipment, the vehicle state, or the vehicle environment when the user permits the execution of the application that has output the first command. The permission condition is stored in the memory 12. In the present embodiment, the vehicle equipment information stored in the memory 12 in S106 in the past processing cycle corresponds to the permission condition.

That is, when determining in S105 that the comparison condition does not match the permission condition, the processing section 71 again inquires of the user whether or not to execute the first command.

On the other hand, when determining in S105 that the notification for inquiring whether to execute the application that has output the first command has not been output yet, the processing section 71 proceeds to S107.

In step S106, the processing section 71 determines whether or not the user has permitted the execution of the application that has output the first command. In the present embodiment, the processing section 71 determines whether or not the user has permitted the hazard operation.

When determining in S106 that the user has permitted the execution of the application that has output the first command, the processing section 71 stores the permission condition that is a condition when the user has permitted the execution in the memory 12. Thereafter, the processing section 71 proceeds to S104. That is, in a case where the user has permitted the execution of the application in response to the inquiry, the processing section 71 permits output of the second command based on the first command regardless of the determination result in S103. When determining in S105 that the comparison condition matches the permission condition, the processing section 71 also determines in S106 that the user has permitted the execution of the application that has output the first command.

On the other hand, when determining in S106 that the user has not permitted the execution of the application that has output the first command, the processing section 71 terminates this processing without executing the application that has output the first command.

In S107, the processing section 71 notifies the user that the application that has output the first command cannot be executed, and in addition, inquires of the user whether to execute the application that has output the first command. At the same time, the processing section 71 also notifies the user of the reason why the application that has output the first command cannot be executed. Thereafter, the processing section 71 terminates this processing. Here, the processing section 71 may differentiate a notification means to the user depending on the situation. For example, in a case where the user is not in the vehicle and operates the execution of the application using a mobile terminal such as a smartphone from the outside of the vehicle, the processing section 71 may display the notification on the display screen of the mobile terminal. Furthermore, for example, in a case where the user is in the vehicle and operates the execution of the application using the in-vehicle device, the processing section 71 may display the notification on the in-vehicle display.

Here, even in a case where it is determined in S105 that the notification inquiring whether or not to execute the application that has output the first command has not been output yet, the processing section 71 skips the processing of S107 in a case where it is set in advance not to notify the application. The notification setting processing of setting whether or not to inquire of the user about the application will be described in detail later.

### 1-4. Notification Setting Processing

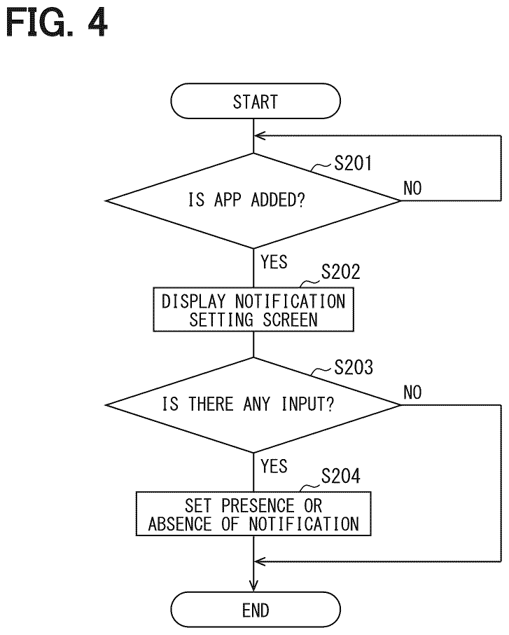

The notification setting processing performed by the processing section 71 will be described with reference to the flowchart of FIG. 4. This processing is processing performed when an application is newly added.

First, in S201, the processing section 71 determines whether or not a new application is added.

When determining in S201 that the new application is added, the processing section 71 proceeds to S202.

On the other hand, when determining in S201 that no new application is added, the processing section 71 repeats S201.

In step S202, the processing section 71 displays a notification setting screen on a monitor, for example. On the notification setting screen, various settings can be made for the application determined to be newly added in S201. For example, it is possible to set whether or not to make an inquiry in S105 described above, that is, to set “whether or not to inquire of the user whether or not to execute in a case where an operation request is made at a timing that may not meet the intention of the user”.

Subsequently, in S203, the processing section 71 determines whether or not there is input from the notification setting screen.

When determining in S203 that there is input from the notification setting screen, the processing section 71 proceeds to S204.

On the other hand, when determining in S203 that there is no input from the notification setting screen, the processing section 71 skips the processing of S204 and terminates this notification setting processing.

In S204, the processing section 71 sets the presence or absence of the inquiry input from the notification setting screen. Thereafter, the processing section 71 terminates this notification setting processing.

The method of setting whether or not to make an inquiry is not limited to the method using the notification setting screen. For example, the processing section 71 may receive the setting content as to whether or not to make an inquiry using a communication means such as a mobile terminal of the user, and may set whether or not to make an inquiry in accordance with the setting content.

### 1-5. Effects

According to the embodiment described in detail above, the following effects can be obtained.

(1a) When determining in S103 that the first command does not meet the intention of the user, the processing section 71 does not proceed to S104 and does not output the second command based on the first command. According to such a configuration, it is possible to suppress the execution of the application regardless of the intention of the user.

(1b) The processing section 71 determines whether or not the first command meets the intention of the user on the basis of at least one of the vehicle equipment, the vehicle state, or the vehicle environment. According to such a configuration, since the intention of the user is determined on the basis of the information of the vehicle equipment, the vehicle state, and the vehicle environment of the vehicle used by the user, the intention of the user can be appropriately determined.

(1c) In S107, the processing section 71 notifies the user that the application that has output the first command cannot be executed, and in addition, inquires of the user whether to execute the application that has output the first command. Then, in a case where the execution of the application is permitted by the user in response to the inquiry, the processing section 71 permits the output of the second command based on the first command regardless of the determination result in S103. According to such a configuration, the user can know that the application cannot be executed. In addition, it is possible to reflect the intention of the user as to whether or not to execute the application.

(1d) When determining in S105 that the comparison condition matches the permission condition, the processing section 71 determines in S106 that the user has permitted the execution of the application that has output the first command, and outputs the second command based on the first command without making an inquiry to the user. According to such a configuration, when it is not necessary to confirm the intention of the user again, it is possible to prevent the user from feeling bothersome by not notifying.

(1e) When determining in S105 that the comparison condition does not match the permission condition, the processing section 71 again inquires of the user whether to execute the first command. According to such a configuration, in a case where the situation has changed from when the user permitted the execution of the application last time, it is possible to confirm the intention of the user again.

(1f) In step S107, the processing section 71 also notifies the user of the reason why the application that has output the first command cannot be executed. According to such a configuration, the user can know the reason why the application that has output the first command cannot be executed, and the user can determine whether or not to execute the application in consideration of the reason.

(1g) The processing section 71 can set whether or not to inquire of the user whether or not to execute the application at the time of adding the application. Then, even in a case where it is determined in S105 that a notification inquiring whether or not to execute the application that has output the first command has not been output yet, when it is set in advance not to notify the user of the application, the processing section 71 can skip the processing of S107 and change the processing so as not to notify the user of the application. According to such a configuration, it is possible to set the setting in consideration of whether or not the notification is suitable. For example, it is possible to set not to make an inquiry about an application that requires real-time property and has a possibility of performance deterioration when the application is executed after waiting for an answer of a notification.

### 2. Other Embodiments

Although the embodiment of the present disclosure has been described above, it is needless to say that the present disclosure is not limited to the above embodiment and can take various forms.

(2a) In the above embodiment, a series of flows in a case where the hazard operation request is received from the service application 6 has been described. In addition, it has been exemplified that in a case where the function of the car finder is unnecessary and the unintended turning on of the hazard lamp is inappropriate as in a case where the vehicle is traveling, it is determined that it does not meet the intention of the user. That is, in the above embodiment, the case where the first command is input at a timing not intended by the user has been exemplified. However, the request received from the service application 6 is not limited to the hazard operation request. For example, a case where an air conditioner operation request is received from the service application 6, that is, a case where a first command with the content not intended by the user is input will be described. Hereinafter, only differences from the processing in a case where the hazard operation request is received from the service application 6 will be described.

In step S102, the processing section 71 determines whether or not a new first command is a command indicating the air conditioner operation request. When determining in S102 that the new first command is the command indicating the air conditioner operation request, the processing section 71 proceeds to S103.

On the other hand, when determining that the new first command is not the command indicating the air conditioner operation request in S102, the processing section 71 returns to S101.

In S103, the processing section 71 determines whether or not the air conditioner operation request meets the intention of the user on the basis of the vehicle state. More specifically, the processing section 71 determines whether or not the air conditioner operation request meets the intention of the user on the basis of the state of an air conditioner switch and the temperature inside the vehicle. For example, in a case where the air conditioner operation request to switch to cooling with a set temperature of 18 degrees is input when the air conditioner switch is on heating and the temperature inside the vehicle is 26 degrees, the processing section 71 determines that the air conditioner operation request does not meet the intention of the user.

When determining in S103 that the air conditioner operation request meets the intention of the user, the processing section 71 proceeds to S104. On the other hand, when determining in S103 that the air conditioner operation request does not meet the intention of the user, the processing section 71 proceeds to S105.

In step S104, the processing section 71 outputs a second command based on the first command to the HVAC control section 98 for controlling the air conditioner. The HVAC control section 98 executes the operation control of the object to be controlled on the basis of the second command.

(2b) In the above embodiment, the configuration in which the processing section 71 determines in S103 whether or not the first command meets the intention of the user has been exemplified. However, as indicated by a dotted line in FIG. 3, the processing section 71 may perform processing of S301 before the processing of S103.

More specifically, in S301, the processing section 71 may perform processing as a safety determination section that first determines whether or not vehicle safety is maintained when the first command is accepted. In this case, the processing section 71 may determine whether or not the vehicle safety is maintained when the first command is accepted on the basis of at least one of the vehicle equipment, the vehicle state, or the vehicle environment.

Here, “vehicle safety is maintained” means that user safety is prioritized, and the processing section 71 rejects a first command to open the door while traveling at 100 km/h, for example. When determining in S301 that the vehicle safety is maintained when the first command is accepted, the processing section 71 may proceed to S103 and determine whether or not the first command meets the intention of the user.

On the other hand, when determining in S301 that the vehicle safety is not maintained when the first command is accepted, the processing section 71 may skip the subsequent processing and terminate the processing. According to such a configuration, it is possible to determine whether or not to accept the first command in consideration of both the viewpoint of the vehicle safety and the viewpoint of the intention of the user. Therefore, the application can be executed more safely and in accordance with the intention of the user. The processing of S301 is processing obtained by separating a part of the processing of S103, and in the above embodiment, the processing of S301 is included in the processing of S103.

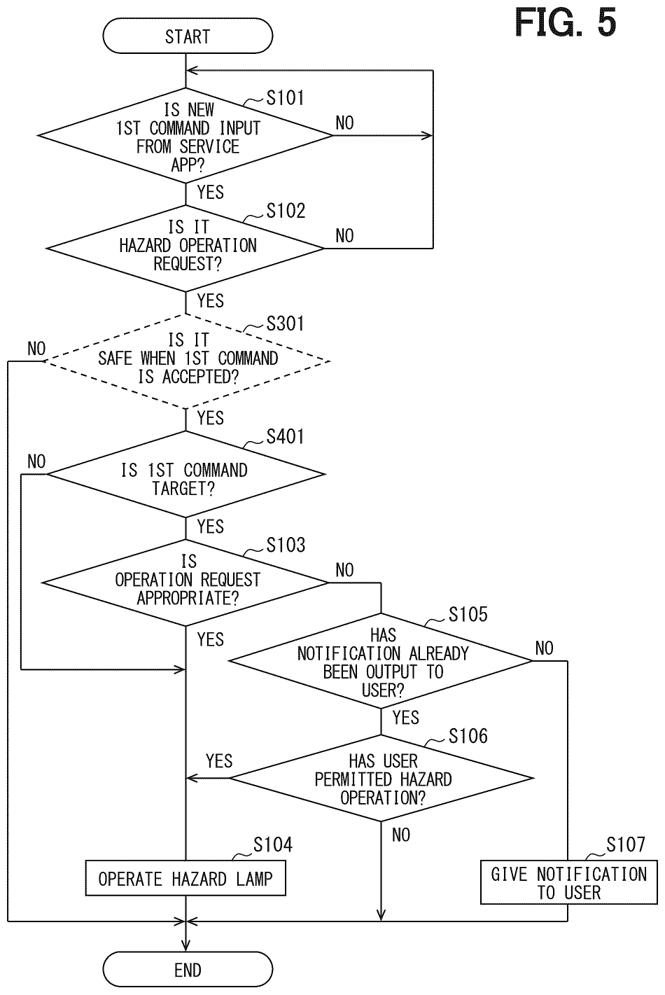

(2c) In the above embodiment, the configuration in which the processing section 71 determines whether or not the first command meets the intention of the user in S103 has been exemplified. However, as illustrated in FIG. 5, by performing the processing of S401 before the processing of S103, the processing section 71 may determine whether or not the first command is a determination target to be determined in S103 as the acceptance determination section.

The determination processing of S401 is processing corresponding to a determination target determination section of the present disclosure. In this determination processing, for example, depending on a case where the first command is a data acquisition command for state recognition, the type of the first command or the applications 61 to 64 to which the first command is input, or the like, it may not be necessary to determine whether or not the first command is appropriate in S103.

Therefore, in FIG. 5, in the determination processing of S401, it is determined whether or not the first command is the determination target in S103 from the command content, the type, or the like of the first command, and if the first command is not the determination target in S401, the processing proceeds to S104 without performing the processing of S103.

As a result, for example, with respect to the first command from an application involved in safety or an application requiring real-time property, the control such as the hazard operation of S104 can be executed without performing the determination processing of S103, and the safety of the control can be enhanced.

(2d) The multiple ECUs 10 and the methods thereof described in the present disclosure may be implemented by a dedicated computer provided by a processor and memory programmed to perform one or more functions implemented by a computer program. Alternatively, the multiple ECUs 10 and the methods thereof described in the present disclosure may be implemented by a dedicated computer provided by a processor with one or more dedicated hardware logic circuits. Alternatively, the multiple ECUs 10 and the method thereof described in the present disclosure may be implemented by one or more special purpose computers configured by a combination of a processor and a memory programmed to execute one or multiple functions and a processor configured by one or more hardware logic circuits. The computer program may be stored in a computer-readable non-transitory tangible storage medium as instructions to be executed by a computer. The method for implementing the functions of respective units included in the multiple ECUs 10 does not necessarily need to include software, and all of the functions may be implemented with the use of one or more hardware circuits.

(2e) The multiple functions of one component in the above embodiments may be implemented by multiple components, or a function of one component may be implemented by multiple components. Multiple functions of multiple configuration elements in the above embodiments may be implemented by one configuration element, or one function implemented by multiple configuration elements may be implemented by one configuration element. Part of the configuration of the above embodiment may be omitted. At least a part of the configuration of the above embodiment may be added to or substituted for the configuration of the other embodiment.

(2f) In addition to the vehicle control system 1 described above, the present disclosure can also be implemented in various manners, such as the ECUs 10 configuration the vehicle control system 1, a vehicle control program for causing a computer to function as the ECUs 10, a non-transitory tangible storage medium such as a semiconductor memory in which the program is recorded, and a vehicle control method.

What is claimed is:

1. A vehicle control device mounted on a vehicle and configured to control the vehicle, the vehicle control device comprising
a cooperation control section configured to implement cooperation between an application configured to provide a service to the vehicle and a functional block configured to perform predetermined processing in the vehicle,
wherein
the functional block includes an output section configured to convert a first command represented in a form independent of the vehicle and transmitted from the application into a second command in a form dependent on the vehicle and output the second command to an operation control section for controlling an object to be controlled,
the cooperation control section is configured to transfer the first command transmitted from the application to the functional block, and
the vehicle control device further comprises:
an acceptance determination section configured to determine whether the first command meets an intention of a user; and
an output control section configured not to cause the output section to output the second command in a case where the acceptance determination section determines that the first command does not meet the intention of the user.

2. The vehicle control device according to claim 1, wherein
the acceptance determination section determines whether the first command meets the intention of the user on a basis of at least one of vehicle equipment, a vehicle state, or a vehicle environment.

3. The vehicle control device according to claim 1, further comprising:
a notification section configured to, in a case where the acceptance determination section determines that the first command does not meet the intention of the user, notify the user that an application that has output the first command cannot be executed, and additionally, inquire of the user whether to execute the application that has output the first command; and
an output permission section configured to, in a case where execution of the application is permitted in response to an inquiry, permit the output section to output the second command based on the first command regardless of a determination result by the acceptance determination section.

4. The vehicle control device according to claim 3, further comprising
a notification setting section configured to be able to set whether to inquire of the user using the notification section at a time of adding the application,
wherein
the notification section changes whether to make an inquiry to the user depending on setting by the notification setting section.

5. The vehicle control device according to claim 3, further comprising:
a storage section configured to store, in a memory, a permission condition that is at least one of vehicle equipment, a vehicle state, or a vehicle environment when execution of an application that has output the first command is permitted by the user, in a case where the execution of the application is permitted in response to an inquiry from the notification section; and
a matching determination section configured to determine, after the permission condition is stored, whether a comparison condition that is at least one of the vehicle equipment, the vehicle state, or the vehicle environment when the first command related to the application is input matches the permission condition,
wherein
in a case where the matching determination section determines that the comparison condition matches the permission condition, the notification section does not make an inquiry to the user, and the output permission section permits the output section to output the second command based on the first command.

6. The vehicle control device according to claim 5, wherein
in a case where the matching determination section determines that the comparison condition does not match the permission condition, the notification section again inquires of the user whether to execute the first command.

7. The vehicle control device according to claim 3, wherein
the notification section also notifies the user of a reason why an application that has output the first command cannot be executed.

8. The vehicle control device according to claim 1, wherein
the acceptance determination section further includes a safety determination section that determines whether vehicle safety is maintained when the first command is accepted, and
the acceptance determination section determines whether the first command meets an intention of a user in a case where the safety determination section determines that the vehicle safety is maintained when the first command is accepted.

9. The vehicle control device according to claim 1, wherein
the acceptance determination section further includes a determination target determination section that determines whether the first command transmitted from the application is a determination target of the acceptance determination section, and
in a case where the determination target determination section determines that the first command is the determination target, the acceptance determination section determines whether the first command meets an intention of a user.

10. A vehicle control system comprising:
a plurality of electronic control devices that control an object to be controlled that is vehicle equipment; and
a vehicle control device communicably connected to the plurality of electronic control devices,
wherein
the vehicle control device includes
a cooperation control section configured to implement cooperation between an application configured to provide a service to the vehicle and a functional block configured to perform predetermined processing in a vehicle,
the functional block includes an output section configured to convert a first command represented in a form independent of the vehicle and transmitted from the application into a second command in a form dependent on the vehicle and output the second command to the electronic control device for controlling the object to be controlled,
the cooperation control section is configured to transfer the first command transmitted from the application to the functional block, and
the vehicle control device further includes an acceptance determination section configured to determine whether the first command meets an intention of a user, and
an output control section configured not to cause the output section to output the second command in a case where the acceptance determination section determines that the first command does not meet the intention of the user, and
at least one of the plurality of electronic control devices includes a target control section that accepts the second command and controls the object to be controlled.

11. An acceptance determination method performed by a vehicle control device mounted on a vehicle and configured to control the vehicle, the acceptance determination method comprising:
when a first command from an application is input, outputting a second command based on the first command to an operation control section for controlling an object to be controlled;
determining whether the first command meets an intention of a user; and
not outputting the second command in a case where it is determined that the first command does not meet the intention of the user.

12. A non-transitory computer readable storage medium storing a program that causes a computer mounted on a vehicle to implement:
a function of, when a first command from an application is input, outputting a second command based on the first command to an operation control section for controlling an object to be controlled;
a function of determining whether the first command meets an intention of a user; and
a function of not outputting the second command in a case where it is determined that the first command does not meet the intention of the user.
